(19) United States
(12) Patent Application Publication
(10) Pub. No.: US 2021/0049625 A1
(43) Pub. Date: Feb. 18, 2021

(54) SYSTEM AND METHOD FOR USING VEHICLE DATA FOR FUTURE VEHICLE DESIGNS

(71) Applicant: Toyota Motor North America, Inc., Plano, TX (US)

(72) Inventor: Narendran Narayanasamy, Irvine, CA (US)

(21) Appl. No.: 16/543,223

(22) Filed: Aug. 16, 2019

(51) Int. Cl. G06Q 30/02; G06K 9/00

(52) U.S. Cl. CPC G06Q 30/0203; G06K 9/00845; G06Q 30/0282

(57) ABSTRACT

Methods and systems for improving vehicle design. The system includes a vehicle sensor configured to detect whether a vehicle component is engaged by a user of the vehicle. The system includes a user reaction sensor configured to detect user reaction data when the vehicle sensor detects the vehicle component is engaged by the user of the vehicle. The system includes a transceiver configured to communicate the user reaction data to a remote data server. The system includes a remote data server configured to receive the user reaction data from the vehicle and other user reaction data from a plurality of other vehicles and determine one or more subsequent design suggestions. The system also includes a computing device configured to execute vehicle design software for designing a subsequent vehicle design based on the one or more subsequent design suggestions.

### BACKGROUND

### 1. Field

This specification relates to a system and a method for designing vehicles based on vehicle data.

### 2. Description of the Related Art

Users and drivers of vehicles have various preferences regarding the vehicles that they drive or occupy. For example, some drivers prefer the air conditioning temperature control to be a knob and others prefer for it to be buttons and others still prefer for it to be a sliding switch. Some features may be disfavored by a majority of drivers and users, and in some situations, these features are addressed in subsequent versions of the vehicle. However, in many situations, drivers and users may not be able to identify or articulate exactly what they do not like about a vehicle. In many other situations, drivers or users may feel that their dislikes are trivial, and do not express them. As a result, the improvement of vehicle design may not be as responsive as possible.

Thus, there is a need for a faster and more focused manner of identifying improvements to vehicle design.

### SUMMARY

What is described is a system for improving vehicle design. The system includes a vehicle sensor of a vehicle configured to detect whether a vehicle component is engaged by a user of the vehicle. The system also includes a user reaction sensor of the vehicle configured to detect user reaction data when the vehicle sensor detects the vehicle component is engaged by the user of the vehicle. The system also includes a transceiver of the vehicle configured to communicate the user reaction data to a remote data server. The system also includes a remote data server configured to receive the user reaction data from the vehicle and other user reaction data from a plurality of other vehicles and determine one or more subsequent design suggestions based on the user reaction data and the other user reaction data. The system also includes a computing device coupled to the remote data server and configured to execute vehicle design software for designing a subsequent vehicle design based on the one or more subsequent design suggestions.

Also described is a system for suggesting a subsequent vehicle for a user. The system includes a vehicle sensor of a current vehicle associated with a vehicle component and configured to detect whether the vehicle component is engaged by the user of the current vehicle. The system also includes a user reaction sensor of the current vehicle configured to detect user reaction data when the vehicle sensor detects the associated vehicle component is engaged by the user of the current vehicle. The system also includes a transceiver of the current vehicle configured to communicate the user reaction data to a remote data server. The system also includes a remote data server configured to receive the user reaction data from the current vehicle and determine one or more suggested subsequent vehicles based on the user reaction data. The system also includes a computing device coupled to the remote data server and configured to display the one or more suggested subsequent vehicles.

Also described is a method for improving vehicle design. The method includes detecting, by a vehicle sensor of a vehicle, whether a vehicle component is engaged by a user of the vehicle. The method also includes detecting, by a user reaction sensor of the vehicle, user reaction data when the vehicle sensor detects the vehicle component is engaged by the user of the vehicle. The method also includes communicating, by a transceiver of the vehicle, the user reaction data to a remote data server. The method also includes receiving, by a remote data server, the user reaction data from the vehicle. The method also includes determining, by the remote data server, one or more subsequent design suggestions based on the user reaction data. The method also includes executing, by a computing device coupled to the remote data server, vehicle design software for designing a subsequent vehicle design based on the one or more subsequent design suggestions.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 illustrates an interior of a vehicle with sensors, according to various embodiments of the invention.

FIG. 2 illustrates a system for using user reaction data for future vehicle designs, according to various embodiments of the invention.

FIGS. 3A-3B illustrate a system for using user reaction data to suggest a different vehicle, according to various embodiments of the invention.

FIG. 4 illustrates a block diagram of the system, according to various embodiments of the invention.

FIG. 5 illustrates a process for using user reaction data for future vehicle designs, according to various embodiments of the invention.

FIG. 6 illustrates a process for using user reaction data to suggest a different vehicle, according to various embodiments of the invention.

### DETAILED DESCRIPTION

Disclosed herein are systems, vehicles, and methods for improving the design of a vehicle. The systems and methods described herein detect whether an occupant of the vehicle is engaging with a vehicle component, and the occupant's reaction to the engaging of the vehicle component is detected. For example, when the occupant is adjusting the volume of the radio, the occupant reaction is detected. The reaction is then analyzed to determine whether the reaction was a positive one, a neutral one, or a negative one. The reactions of many occupants are aggregated, and vehicle design adjustments may be made based on the aggregated reactions. The systems and methods described herein may also be used to identify which vehicle components a particular user likes and which vehicle components a particular user dislikes, and future vehicles may be suggested to the user based on the user's detected preferences.

The systems and methods described herein are an improvement to conventional methods of relying on the judgment of designers or surveying users. The systems and methods described herein provide a larger sample size of data points and can provide more honest feedback from the users compared to conventional approaches.

As used herein, “driver” may refer to a human being driving the vehicle when the vehicle is a non-autonomous vehicle, and/or “driver” may also refer to one or more computer processors used to autonomously or semi-autonomously drive the vehicle. “User” may be used to refer to the driver or occupant of the vehicle when the vehicle is a non-autonomous vehicle, and “user” may also be used to refer to an occupant of the vehicle when the vehicle is an autonomous or semi-autonomous vehicle.

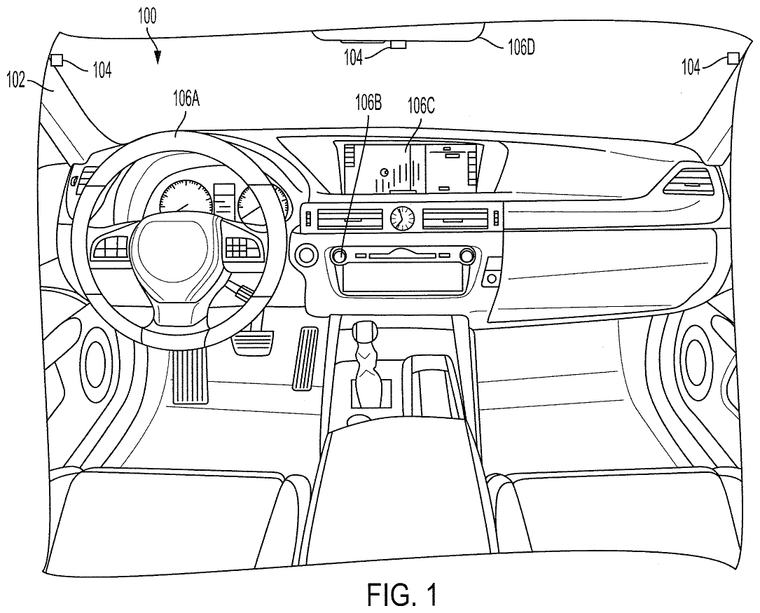

FIG. 1 illustrates an interior 100 of a vehicle 102. The vehicle 102 includes multiple user reaction sensors 104. The user reaction sensors 104 may include image sensors (e.g., cameras) configured to detect image data inside the vehicle 102. The user reaction sensors 104 may also include audio sensors (e.g., microphones) configured to detect audio data inside the vehicle 102.

The vehicle 102 also includes multiple vehicle sensors 106 (e.g., 106A-106D). The vehicle sensors 106 are configured to detect whether the associated vehicle component is engaged. As used herein, “engaged” may be used to refer to a component being activated, interacted with, or manipulated by a user of the vehicle 102.

For example, the vehicle sensors 106 may include a steering wheel sensor 106A, a knob sensor 106B, a display screen sensor 106C, and a rear-view mirror sensor 106D. The steering wheel sensor 106A may include a touch sensor located on the steering wheel configured to detect when the steering wheel is being touched by a user, or a rotation sensor configured to detect when the steering wheel is being turned. The knob sensor 106B may include a rotation sensor configured to detect when the knob is being turned. The display screen sensor 106C may include a touch sensor configured to detect when the display screen is being touched. The rear-view mirror sensor 106D may include a touch sensor configured to detect when the rear-view mirror is being touched or adjusted.

The user reaction sensors 104 are configured to detect user reaction data in response to a vehicle sensor 106 detecting that a particular vehicle component is engaged. The user reaction data may include image data or audio data. The user reaction data may be received by one or more processors, and the one or more processors may determine a user reaction based on the user reaction data. The one or more processors may be local to the vehicle 102 or may be on a remote data server.

The user reaction may be positive, negative, or neutral, for example. The user reaction may be used as feedback to be used in future designs of the vehicle. For example, a particular user may express a positive user reaction when engaging the infotainment display but may express a negative user reaction when engaging the air conditioning and heating functions of the vehicle 102. If a threshold number or percentage of users give a positive reaction to a vehicle component (e.g., the infotainment display), the vehicle component may be made more prominent in future designs or may be left unaltered. If a threshold number or percentage of users give a negative reaction to a vehicle component (e.g., the air conditioning and heating functions), the vehicle component may be made less prominent in future designs or may be changed.

The user reaction data may be analyzed by the one or more processors to determine the user reaction using facial recognition techniques, voice recognition techniques, or body language detection techniques, for example. The one or more processors may compare the user reaction data with stored audio data or image data corresponding to various reaction classifications. The one or more processors may use machine learning along with training data to train the one or more processors to detect the user reaction based on the user reaction data. For example, the training data may include images and/or audio associated with various reactions, and when the user reaction data includes images and/or audio that is similar to the training data, the one or more processors may determine a corresponding user reaction.

The user reaction sensors 104 may be used to detect user reaction data at various times. In some embodiments, the user reaction sensors 104 are activated any time the vehicle sensors 106 detect engagement. In some embodiments, the user reaction sensors 104 only detect user reaction data when the vehicle 102 is a display vehicle or test drive vehicle at a dealership.

The vehicle sensors 106 may also be configured to detect vehicle sensor data to determine a function or action of the associated vehicle component when the user reaction sensors 104 detect user reaction data. For example, the vehicle sensor data and the user reaction data may indicate that a positive reaction was detected when the auto-tinting feature of the rear-view mirror is activated.

The user reaction data and corresponding user reactions may be associated with a particular user. The user reaction data of the particular user may be analyzed to determine preferences of the particular user, and the determined preferences may be used to recommend other subsequent vehicles to the particular user.

While FIG. 1 illustrates an interior of the vehicle 102, the user reaction sensors 104 may be located near the exterior of the vehicle 102, and the user reaction sensors 104 may be able to detect user reaction data of the user outside of the vehicle 102 when the user engages exterior vehicle components, such as a door handle, a trunk, or a front grille, for example.

As described herein, the user reaction data across a plurality of users may be used by vehicle designers designing future vehicles.

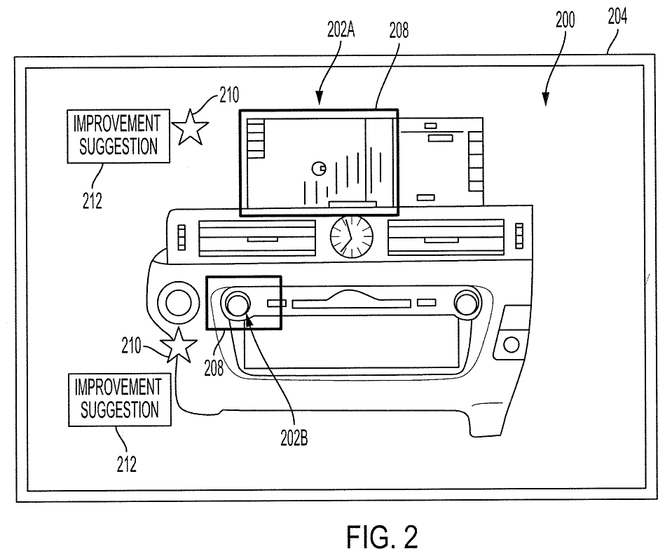

FIG. 2 illustrates a user interface 200 displayed by a display screen 204 for designing a vehicle (e.g., vehicle 102). The user interface 200 may be generated by computer software executed by a computing device that is specially programmed and specially constructed to facilitate computer-aided vehicle design.

The computing device may be configured to execute vehicle design software for designing a vehicle. The computing device may include an input device, such as a mouse, a keyboard, or a stylus, and an output device, such as a display. The vehicle design software may take as inputs, instructions from the designer via the input device, to design the vehicle. Designing the vehicle using the vehicle design software may include specifying where various vehicle components are to be located and how the various vehicle components are to appear visually. The vehicle design software may use the output device to show the designer the currently designed vehicle, so that the designer may make adjustments using the input device. The vehicle design software enables the designer to design the vehicle without physically creating the vehicle components and adjusting them. Instead, the vehicle design software virtually creates the vehicle components so that they may be adjusted quickly and efficiently.

The computing device may automatically analyze the user reaction data from multiple first version vehicles to determine improvements that may be made to the design of the second version of the vehicle. For example, a plurality of first version vehicles may detect user reaction data as described herein. The plurality of first version vehicles may communicate the user reaction data to the computing device. The computing device may analyze the user reaction data from the plurality of first version vehicles to determine one or more vehicle components to improve for the second version of the vehicle.

The computing device may use one or more algorithms to determine whether an improvement should be suggested. For example, the computing device may determine a frequency of non-positive (e.g., negative or confused) reaction associated with a vehicle component, and when the frequency of non-positive reaction exceeds a threshold frequency, the computing device may determine that an improvement may be made to the vehicle at the particular vehicle component. For example, the display 202A may be engaged 12,480 times and the user reaction data may indicate that in 7,222 of those times (57.87%), the user expressed a non-positive reaction. The threshold frequency may be 50%, so in this example, the display 202A may be flagged or identified as potentially being redesigned or improved.

The computing device may further identify a function or action being performed using the particular vehicle component when the non-positive reaction was detected in the user reaction data. The vehicle sensors (e.g., vehicle sensors 106) may detect vehicle sensor data that may be provided along with the user reaction data. The two sets of data may be cross-referenced using a time-stamp so the computing device is able to determine an action performed by the vehicle component when various reactions are detected in the user reaction data.

The computing device may determine whether a particular function or action is associated with a non-positive reaction. When the frequency of a particular function or action triggering a non-positive reaction exceeds a threshold frequency, the computing device may determine a more specific improvement to make. For example, it may be determined that 80% of the time that a user expresses a non-positive reaction, the display 202A was showing suggested points of interest based on historical location data, so an improvement to the showing of suggested points of interest may be made. The vehicle sensor data at the time of the non-positive reaction may also be used to determine whether there are other reasons for the non-positive reaction. For example, it may be determined that 75% of the time that a user expresses a non-positive reaction when using the display 202A, traffic slowdown was being displayed by the display 202A. In this example, the computing device may determine that no improvement is necessary, as the non-positive reactions were, in the vast majority of the time, not associated with the design or functionality of the vehicle.

Conventionally, the vehicle designer may not have taken data of this granularity into consideration when designing the vehicle. The vehicle designer may have considered customer survey data, but may not have taken unsolicited, real-world reactions into account. In this way, the systems and methods described herein are an improvement to existing computer-based vehicle design technology. The systems and methods described herein improve the previously manually performed task of designing a vehicle by automating the identification of improvements to be made to the vehicle. The automatic identification of improvements is a process that has not been conventionally performed by vehicle designers. The safety, efficiency, and accuracy of vehicle design improvements may be improved by the systems and methods described herein.

The computing device may automatically display an alert on the user interface 200 to indicate to the human designer of the vehicle of one or more subsequent design suggestions that may be made. The alert may include a box 208 or other shape identifying an area to be improved. The alert may also include an icon 210 to attract the attention of the designer. The alert may also include a text box 212 explaining the subsequent design suggestion. The text box 212 may include an identification of the area to be improved (e.g.,

“IMPROVE KNOB WHEN USED TO ADJUST CLIMATE CONTROL TEMPERATURE”). The text box 212 may include information based on the sensor data (e.g., “65% OF USERS WHO MAKE CALLS USING THE INFOTAINMENT UNIT HAVE NON-POSITIVE REACTIONS”). The text box 212 may include specific information on how to improve the vehicle (e.g., “REDUCE GLARE FROM THE DISPLAY SCREEN DURING THE DAY”).

The alert may also be used to indicate whether a newly-added design feature is likely to cause problems based on the sensor data. For example, if the proposed new design of the vehicle were to move a button or dial as compared to a previous version, and the vehicle sensor data and user reaction data indicates that the vehicle users may be highly satisfied with the current button or dial, the computing device may generate an alert to display. The alert may include a text box with general guidelines (e.g., “USERS ALREADY HAVE POSITIVE REACTIONS TO THIS VEHICLE FEATURE”).

In some embodiments, instead of alerting the vehicle designer to subsequent design suggestions which may be made, the computing device automatically determines changes to make to the vehicle to improve one or more aspects of the vehicle based on the vehicle data and user reaction data, and the computing device automatically designs the subsequent vehicle to incorporate the determined subsequent design suggestions.

As described herein, the user reaction data for a specific user may be used to recommend future vehicle purchases or leases.

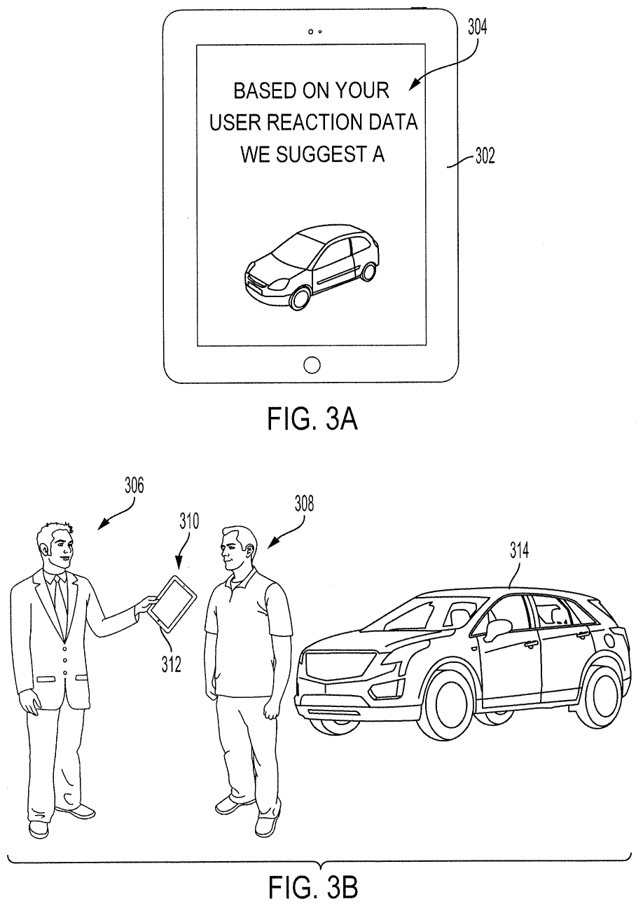

FIG. 3A illustrates a user interface 304 displayed by a display screen of a device 302. The user interface 304 may be generated by computer software executed by a computing device that is specially programmed and specially constructed to facilitate vehicle sales.

The computing device may automatically analyze the vehicle sensor data and the user reaction data from the user's vehicle or any other one or more additional vehicles the user was inside, such as a test driving vehicle or a vehicle is a showroom, to determine a recommendation for the user's next vehicle (i.e., a subsequent vehicle for the user). For example, when the user reaction data indicates that the user expresses positive reactions to large display screens with multiple pieces of data shown in the navigation user interface, the user expresses positive reactions to temperature of climate control being adjusted by a knob, and the user expresses non-positive reactions to temperature of climate control being adjusted by buttons, the computing device may search for vehicles that include features that are consistent with the user's reactions, and these one or more suggested subsequent vehicles may be displayed on the user interface 304.

Conventionally, the vehicle purchaser or salesperson may not have taken data of this granularity into consideration when purchasing a vehicle. The vehicle purchaser may have known that they had positive reactions to some vehicle features, but the vehicle purchaser may not have known exactly which vehicle features they had positive reactions to.

The computing device may display in the user interface 304 a suggested vehicle based on the vehicle sensor data and the user reaction data from the user's vehicle or any other vehicle the user was inside. As shown in FIG. 3B, when the driver 308 is speaking with a salesperson 306, the salesperson may view vehicle recommendation data on a user interface 310. The vehicle recommendation data may be determined by the computing device 312 based on the vehicle sensor data and the user reaction data from the user's vehicle 314 or any other vehicle the user was inside. In some embodiments, more than one vehicle may be suggested as a subsequent vehicle for the driver, and each of the multiple suggested vehicles may have a corresponding score indicating a compatibility with the driver or an increase in compatibility with the driver as compared to the driver's current vehicle. Each vehicle may have an associated ideal driver profile, and based on the sensor data, the driver may have a driver profile constructed by a computing device. The driver's profile and the ideal driver profile of each vehicle may be compared to determine a compatibility score between the driver and each vehicle.

The profile associated with the driver 308 may be accessed automatically using a sensor to detect when the driver 308 enters the dealership (e.g., an image sensor and a computing device for automatically identifying the driver based on image data detected from the image sensor or a sensor configured to detect a mobile device in possession of the driver being located within a geographic boundary of the dealership). The profile associated with the driver 308 may be accessed automatically when the driver 308 signs in or otherwise provides information used to look up and access the driver profile.

The one or more suggested subsequent vehicles may be determined by classifying the reactions of the user by comparing the reactions of the user with stored reactions. For example, the reactions of the user may include image data or audio data, and the image data or audio data may be compared with stored image data or audio data associated with various reactions.

The determined reactions may be used to create a list of features that the user prefers and a list of features that the user dislikes. Vehicle features associated with favorable reactions from the user may be included in the list of features that the user prefers, and vehicle features associated with unfavorable reactions from the user may be included in the list of features that the user dislikes. The list of features that the user prefers and the list of features that the user dislikes may be compared with vehicle data of various possible vehicles to determine the one or more suggested subsequent vehicles.

While the systems and methods described herein describe vehicle sales, the systems and methods described herein may also be adapted to be used in other product contexts, such as consumer electronics, where products are being demoed and the reactions of the customer may be detected.

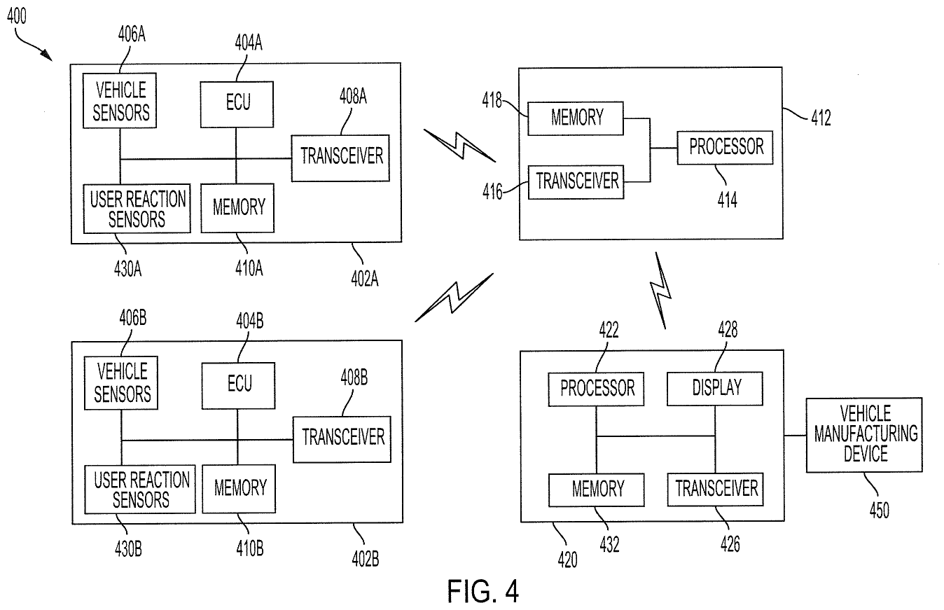

FIG. 4 illustrates a block diagram of the system 400. The system 400 includes a first vehicle 402A and a second vehicle 402B. Components having a letter suffix may be referred to collectively or individually by the number before the letter suffix. For example, vehicle 402 may refer to the first vehicle 402A and the second vehicle 402B collectively or may refer to either the first vehicle 402A or the second vehicle 402B individually. The vehicles 402 may be similar to any of the vehicles described herein, such as vehicle 102.

The vehicle 402 may have an automatic or manual transmission. The vehicle 402 is a conveyance capable of transporting a person, an object, or a permanently or temporarily affixed apparatus. The vehicle 402 may be a self-propelled wheeled conveyance, such as a car, a sports utility vehicle, a truck, a bus, a van or other motor or battery driven vehicle. For example, the vehicle 402 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 402 may be a semi-autonomous vehicle or an autonomous vehicle. That is, the vehicle 402 can be a self-maneuvering, auto-driving vehicle that can navigate without human input. An autonomous vehicle may use one or more sensors and/or a navigation unit to drive autonomously.

The vehicle 402 (e.g., a first vehicle 402A and/or a second vehicle 402B) may have a first version vehicle design. The vehicle 402 includes an ECU 404 (e.g., ECU 404A and 404B) connected to a transceiver 408 (e.g., 408A and 408B), user reaction sensors 430 (e.g., 430A and 430B), a memory 410 (e.g., 410A and 410B), and vehicle sensors 406 (e.g., 406A and 406B). The ECU 404 may be one or more ECUs, appropriately programmed, to control one or more operations of the vehicle. The one or more ECUs 404 may be implemented as a single ECU or in multiple ECUs. The ECU 404 may be electrically coupled to some or all of the components of the vehicle. In some embodiments, the ECU 404 is a central ECU configured to control one or more operations of the entire vehicle. In some embodiments, the ECU 404 is multiple ECUs located within the vehicle and each configured to control one or more local operations of the vehicle. In some embodiments, the ECU 404 is one or more computer processors or controllers configured to execute instructions stored in a non-transitory memory 410. All of the elements of the vehicle 402 may be connected via a communications bus.

As described herein, the vehicle sensors 406 are configured to detect whether the associated vehicle component is engaged. The vehicle sensors 406 may also be configured to detect vehicle sensor data to determine a function or action of the associated vehicle component when the user reaction sensors 430 detect user reaction data.

As described herein, the user reaction sensors 104 are configured to detect user reaction data in response to a vehicle sensor 106 detecting that a particular vehicle component is engaged. The user reaction data may include image data or audio data.

The vehicle 402 may be coupled to a network. The network, such as a local area network (LAN), a wide area network (WAN), a cellular network, a digital short-range communication (DSRC), a LORA (Long Range), the Internet, or any other type of interconnectivity or combinations thereof, connects the vehicle 402 to a remote data server 412.

The transceiver 408 may include a communication port or channel, such as one or more of a Wi-Fi unit, a Bluetooth® unit, a Radio Frequency Identification (RFID) tag or reader, a DSRC unit, a LORA unit, or a cellular network unit for accessing a cellular network (such as 3G, 4G, or 5G) or any other wireless technology. The transceiver 408 may transmit data to and receive data from devices and systems not physically connected to the vehicle. For example, the ECU 404 may communicate with the remote data server 412. Furthermore, the transceiver 408 may access the network, to which the remote data server 412 is also connected.

The vehicle sensors 406 may include a location sensor configured to determine location data. The ECU 404 may use the location data along with map data stored in memory 410 to determine a location of the vehicle. In other embodiments, the location sensor has access to the map data and may determine the location of the vehicle and provide the location of the vehicle to the ECU 404. The location sensor may be a GPS unit, a GLONASS system device, a Galileo system device, or any other global location detection device. The location data may be used to determine location-based trends in the gathered sensor data.

The memory 410 is connected to the ECU 404 and may be connected to any other component of the vehicle. The memory 410 is configured to store any data described herein, such as the vehicle sensor data, the user reaction data, the data received from any other sensors, and any data received from the remote data server 412 via the transceiver 408.

In some embodiments, the ECU 404 determines vehicle improvements or user vehicle preferences based on the vehicle sensor data and the user reaction data. In other embodiments, the processor 414 of a remote data server 412 determines vehicle improvements or user vehicle preferences based on the vehicle sensor data and the user reaction data.

The vehicle sensor data and the user reaction data may be communicated from the vehicle 402 to the remote data server 412 via the transceiver 408 of the vehicle 402 and the transceiver 416 of the remote data server 412. The remote data server 412 includes a processor 414, a transceiver 416, and a memory 418, all connected to each other via a communications bus. The processor 414 (and any processors described herein) may be one or more computer processors configured to execute instructions stored on a non-transitory memory.

The memory 418 may be a non-transitory memory configured to store vehicle sensor data and user reaction data of a plurality of vehicles 402 and/or users. The user data may be indexed by a user identifier associated with the user, and the user identifier may be associated with vehicle sensor data and user reaction data when the vehicle sensor data and the user reaction data are communicated from the vehicle 402 to the remote data server 412.

The memory 418 may also store data associated with the design and manufacture of the vehicle 402, including materials used and design specifications of the vehicle 402 (e.g., the first version vehicle design). The memory 418 may be a sorted collection of the vehicle sensor data, user reaction data, and/or user identifiers received by the plurality of vehicles. The memory 418 may sort the data in any way that increases the processor's ability to efficiently access the data. The transceiver 416 may be configured to transmit and receive data, similar to transceiver 408.

The remote data server 412 may be communicatively coupled to a computing device 420 used for designing a subsequent version of the vehicle 402 (e.g., a second version vehicle design). The remote data server 412 may be directly connected to the computing device 420 via a data cable or may be connected to the computing device 420 via a network, such as a local area network or the Internet.

The computing device 420 includes a processor 422, a memory 432, a transceiver 426, and a display 428, which may all be connected to each other via a communications bus. The processor 422 may be one or more computer processors configured to execute instructions stored on a non-transitory memory. The memory 432 may be a non-transitory memory configured to store data. The transceiver 426 may be configured to transmit and receive data, similar to transceivers 408 and 416.

In some embodiments, the processor 414 of the remote data server 412 is configured to determine trends based on the sensor data and determine any possible improvements to the vehicle design based on the determined trends. In some embodiments, the processor 422 of the computing device 420 receives the sensor data stored in the memory 418 of the remote data server 412 and the processor 422 of the computing device 420 is configured to determine trends based on the sensor data and determine any possible improvements to the vehicle design based on the determined trends.

The processor 414 of the remote data server 412 and/or the processor 422 of the computing device 420 may use machine learning techniques to determine trends based on the vehicle sensor data and the user reaction data and may also use machine learning techniques to determine any possible improvements. One or more algorithms for determining trends or outliers in the sensor data may also be used to determine any possible improvements.

The processor 422 is configured to render a graphical user interface (e.g., user interface 304) to facilitate designing of the subsequent version of the vehicle 402. As described herein, the user interface may be generated by computer software executed by the computing device 420 that is specially programmed and specially constructed to facilitate computer-aided vehicle design.

Once a possible improvement is determined by the processor 422 of the computing device 420 or the processor 414 of the remote data server 412, the display 428 (e.g., display screen 204) of the computing device 420 may automatically display an alert on the user interface to indicate that an improvement that may be made to the vehicle design based on the sensor data, as described herein.

In some embodiments, instead of alerting the vehicle designer to improvements which may be made via the display 428, the computing device 420 automatically determines changes to make to the vehicle to improve one or more aspects of the vehicle based on the sensor data, and the computing device 420 automatically designs the vehicle to incorporate the determined changes. The computing device 420 may be connected to a vehicle manufacturing device 450 configured to automatically construct a new vehicle based on the second version vehicle design.

In some embodiments, the processor 422 of the computing device 420 is configured to determine one or more suggested subsequent vehicles based on the user reaction data, as described herein. The display 428 of the computing device 420 may be configured to display the determined one or more suggested subsequent vehicles. In these embodiments, the computing device 420 may be a computing device of the user, such as a smartphone or tablet or personal computer, or the computing device 420 may be a computing device of a salesperson, such as a smartphone or tablet or personal computer.

While only two vehicles 402A-402B are shown, any number of vehicles may be used. Likewise, while only one remote data server 412 is shown, any number of remote data servers in communication with each other may be used. Multiple remote data servers may be used to increase the memory capacity of the data being stored across the remote data servers, or to increase the computing efficiency of the remote data servers by distributing the computing load across the multiple remote data servers. Multiple vehicles or sensors may be used to increase the robustness of sensor data. Multiple remote data servers may be interconnected using any type of network, or the Internet.

As used herein, a “unit” may refer to hardware components, such as one or more computer processors, controllers, or computing devices configured to execute instructions stored in a non-transitory memory.

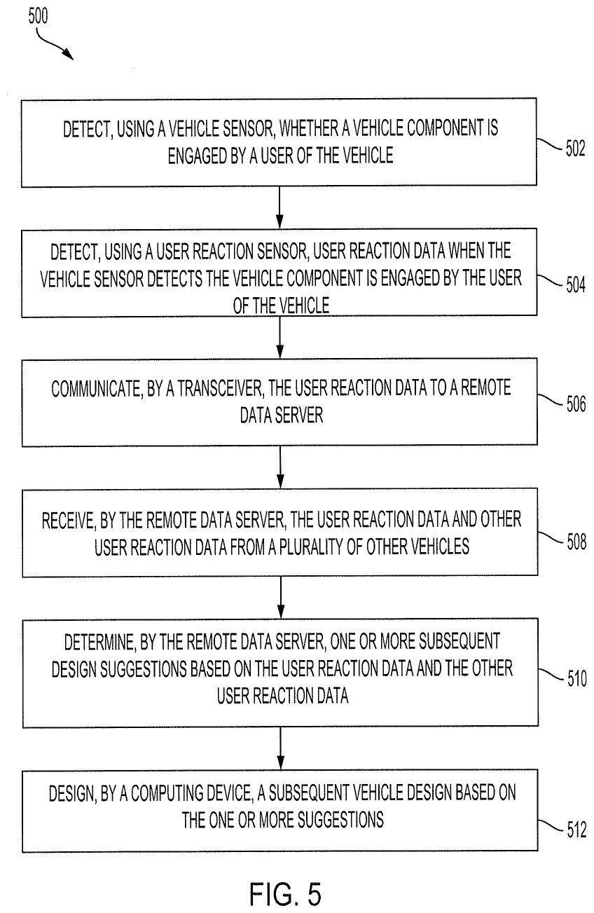

FIG. 5 is a flow diagram of a process 500 for improving vehicle design using the systems and devices described herein.

A vehicle sensor (e.g., vehicle sensor 406) detects whether a vehicle component is engaged by a user of the vehicle (e.g., vehicle 402) (step 502). As described herein, the vehicle sensor may be connected to a respective vehicle component. The vehicle sensor may include a steering wheel sensor, a knob sensor, a display screen sensor, and a rear-view mirror sensor, for example.

A user reaction sensor (e.g., user reaction sensor 430) detects user reaction data when the vehicle sensor detects that the corresponding vehicle component is engaged by the user of the vehicle (step 504). As described herein, the user reaction sensor may include an image sensor or an audio sensor, and the user reaction sensor may include image data or audio data. The user reaction data reflects the reaction of the user to engaging the vehicle component when the vehicle sensor indicates that the vehicle component has been engaged.

A transceiver (e.g., transceiver 408) of the vehicle communicates the user reaction data to a remote data server (e.g., remote data server 412) (step 506). The user reaction data may include a user identifier associated with the user, an identifier of the vehicle component corresponding to the user reaction, an identifier of the vehicle (e.g., make and model and year), and/or the image data or audio data of the user reaction.

The remote data server receives user reaction data from the vehicle and from a plurality of other vehicles (step 508). In some embodiments, one or more subsequent design changes are not determined unless a threshold number of user reaction data is received from a plurality of vehicles. The remote data server may store all of the received user reaction data in a memory (e.g., memory 418). The received user reaction data may be indexed and organized according to the identifier of the vehicle type.

The remote data server determines one or more subsequent design suggestions based on the received user reaction data from all vehicles (step 510). More specifically, a processor (e.g., processor 414) of the remote data server determines the one or more subsequent design suggestions. The processor may analyze the user reaction data to determine a reaction classification for each user reaction. For example, the reaction classifications may be positive, neutral, or negative. The processor may compare the image data or audio data of the user reaction data with stored image data or audio data corresponding to each of the reaction classifications. The user reaction data may also include an identification of a vehicle component associated with the user reaction. The processor may aggregate all of the user reactions and their associated classifications for a particular vehicle component. Based on the classifications of user reactions of the vehicle component, a subsequent design suggestion may be made. For example, when a threshold number or percentage of negative-classified user reactions exceed a threshold number or percentage, the processor may determine a subsequent design suggestion for the vehicle component in question.

A computing device (e.g., computing device 420) coupled to the remote data server designs a subsequent vehicle design based on the one or more subsequent design suggestions (step 512). As described herein, the computing device executes vehicle design software for designing the subsequent vehicle. A display (e.g., display 428) of the computing device may display an indication associated with the one or more subsequent design suggestions for the designer's consideration.

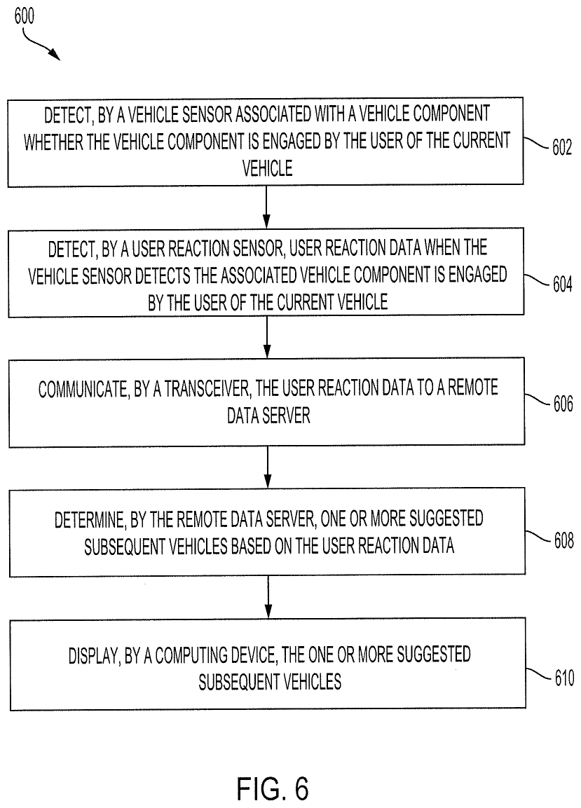

FIG. 6 is a flow diagram of a process 600 for suggesting a subsequent vehicle for a user using the systems and devices described herein.

A vehicle sensor (e.g., vehicle sensor 406) detects whether a vehicle component is engaged by a user of the vehicle (e.g., vehicle 402) (step 602). As described herein, the vehicle sensor may be connected to a respective vehicle component. The vehicle sensor may include a steering wheel sensor, a knob sensor, a display screen sensor, and a rear-view mirror sensor, for example.

A user reaction sensor (e.g., user reaction sensor 430) detects user reaction data when the vehicle sensor detects that the corresponding vehicle component is engaged by the user of the current vehicle (step 604). As described herein, the user reaction sensor may include an image sensor or an audio sensor, and the user reaction sensor may include image data or audio data. The user reaction data reflects the reaction of the user to engaging the vehicle component when the vehicle sensor indicates that the vehicle component has been engaged.

A transceiver (e.g., transceiver 408) of the current vehicle communicates the user reaction data to a remote data server (e.g., remote data server 412) (step 606). The user reaction data may include a user identifier associated with the user, an identifier of the vehicle component corresponding to the user reaction, an identifier of the vehicle (e.g., make and model and year), and/or the image data or audio data of the user reaction.

The remote data server determines one or more suggested subsequent vehicles based on the received user reaction data (step 610). More specifically, a processor (e.g., processor 414) of the remote data server determines the one or more suggested subsequent vehicles. The processor may analyze the user reaction data to determine a reaction classification for each user reaction. For example, the reaction classifications may be positive, neutral, or negative. The processor may compare the image data or audio data of the user reaction data with stored image data or audio data corresponding to each of the reaction classifications. The user reaction data may also include an identification of a vehicle component associated with the user reaction. Based on the classification of user reactions of the vehicle component, one or more subsequent vehicles may be suggested. For example, when a user reaction to the volume knob is classified as being negative, the processor may access a database in memory (e.g., memory 418) to determine which other vehicles have volume knobs that are different from the volume knob of the current vehicle.

A computing device (e.g., computing device 420) coupled to the remote data server displays the one or more suggested subsequent vehicles using a display (e.g., display 428).

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for improving vehicle design, the system comprising:
a vehicle sensor of a vehicle configured to detect whether a vehicle component is engaged by a user of the vehicle;
a user reaction sensor of the vehicle configured to detect user reaction data when the vehicle sensor detects the vehicle component is engaged by the user of the vehicle;
a transceiver of the vehicle configured to communicate the user reaction data to a remote data server;
a remote data server configured to receive the user reaction data from the vehicle and other user reaction data from a plurality of other vehicles, and determine one or more subsequent design suggestions based on the user reaction data and the other user reaction data; and
a computing device coupled to the remote data server, and configured to execute vehicle design software for designing a subsequent vehicle design based on the one or more subsequent design suggestions.

2. The system of claim 1, wherein the remote data server includes a processor configured to analyze the user reaction data and the other user reaction data to determine the one or more subsequent design suggestions by classifying reactions of respective users when engaging the vehicle component.

3. The system of claim 2, wherein the user reaction sensor includes at least one of an image sensor configured to detect image data or an audio sensor configured to detect audio data, and
wherein the processor of the remote data server classifies the reactions by analyzing the image data or the audio data.

4. The system of claim 3, wherein the processor of the remote data server is configured to analyze the image data or the audio data to classify the reactions by comparing the image data or the audio data to stored image data or audio data corresponding to a plurality of reaction classifications.

5. The system of claim 1, wherein the computing device is configured to automatically incorporate the one or more subsequent design suggestions into the subsequent vehicle design.

6. The system of claim 5, further comprising a vehicle manufacturing device connected to the computing device and configured to automatically manufacture a subsequent vehicle based on the subsequent vehicle design.

7. The system of claim 1, further comprising a display screen connected to the computing device,
wherein the computing device is further configured to render a graphical user interface for interacting with a designer, and
wherein the graphical user interface includes an alert indicating to the designer at least one of the one or more subsequent design suggestions.

8. The system of claim 7, wherein the alert includes text associated with the one or more subsequent design suggestions.

9. A system for suggesting a subsequent vehicle for a user, the system comprising:
a vehicle sensor of a current vehicle associated with a vehicle component and configured to detect whether the vehicle component is engaged by the user of the current vehicle;
a user reaction sensor of the current vehicle configured to detect user reaction data when the vehicle sensor detects the associated vehicle component is engaged by the user of the current vehicle;
a transceiver of the current vehicle configured to communicate the user reaction data to a remote data server;
a remote data server configured to receive the user reaction data from the current vehicle and determine one or more suggested subsequent vehicles based on the user reaction data; and
a computing device coupled to the remote data server and configured to display the one or more suggested subsequent vehicles.

10. The system of claim 9, wherein the remote data server includes a processor configured to analyze the user reaction data to determine the one or more suggested subsequent vehicles by classifying reactions of the user when engaging the one or more vehicle components.

11. The system of claim 10, wherein the user reaction sensor includes at least one of an image sensor configured to detect image data or an audio sensor configured to detect audio data, and
wherein the processor of the remote data server classifies the reactions by analyzing the image data or the audio data.

12. The system of claim 11, wherein the processor of the remote data server is configured to analyze the image data or the audio data to classify the reactions by comparing the image data or the audio data to stored image data or audio data corresponding to a plurality of reaction classifications.

13. The system of claim 9, wherein the remote data server is further configured to:
receive additional user reaction data from one or more additional vehicles, each vehicle of the one or more other vehicles having a respective vehicle sensor and a respective user reaction sensor configured to detect the additional user reaction data when a respective vehicle component is engaged by the user, and
determine the one or more suggested subsequent vehicles based on the user reaction data and the additional user reaction data.

14. A method for improving vehicle design, the method comprising:
detecting, by a vehicle sensor of a vehicle, whether a vehicle component is engaged by a user of the vehicle;
detecting, by a user reaction sensor of the vehicle, user reaction data when the vehicle sensor detects the vehicle component is engaged by the user of the vehicle;
communicating, by a transceiver of the vehicle, the user reaction data to a remote data server;
receiving, by a remote data server, the user reaction data from the vehicle;
determining, by the remote data server, one or more subsequent design suggestions based on the user reaction data; and
executing, by a computing device coupled to the remote data server, vehicle design software for designing a subsequent vehicle design based on the one or more subsequent design suggestions.

15. The method of claim 14, further comprising:
receiving, by the remote data server, other user reaction data from a plurality of other vehicles; and
determining, by the remote data server, the one or more subsequent design suggestions based on the user reaction data and the other user reaction data.

16. The method of claim 14, further comprising analyzing, by a processor of the remote data server, the user reaction data to determine the one or more subsequent design suggestions by classifying reactions of the user when engaging the vehicle component.

17. The method of claim 16, wherein the classifying the reactions of the user when engaging the vehicle component comprises comparing, by the processor of the remote data server, the image data or the audio data to stored image data or stored audio data corresponding to a plurality of reaction classifications.

18. The method of claim 14, further comprising automatically incorporating, by the computing device, the one or more subsequent design suggestions into the subsequent vehicle design.

19. The method of claim 18, further comprising automatically manufacturing, by a vehicle manufacturing device connected to the computing device, a subsequent vehicle based on the subsequent vehicle design.

20. The method of claim 14, further comprising rendering, by the computing device, a graphical user interface for interacting with a designer to be displayed by a display, the graphical user interface including an alert indicating to the designer at least one of the one or more subsequent design suggestions.
